(19) United States
(12) Patent Application Publication
(10) Pub. No.: US 2006/0200399 A1
(43) Pub. Date: Sep. 7, 2006

(54) Generating royalty revenue using intellectual property

(75) Inventors: Luis J. Diaz, Green Brook, NJ (US); James A. Digiorgio, Green Brook, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: IDT Corporation, Newark, NJ (US)

(21) Appl. No.: 10/551,440

(22) PCT Filed: Apr. 5, 2004
(86) PCT No.: PCT/US04/07707

§ 371 Date: Sep. 29, 2005

Related U.S. Application Data
(60) Provisional application No. 60/460,307, filed on Apr. 5, 2003.

(51) Int. Cl. G06Q 40/00

(52) U.S. Cl. 705/36 R

(57) ABSTRACT

A system for generating royalty revenue includes: a business entity configured to acquire rights to at least one intellectual property asset from at least one IP owner; a licensing group operating on behalf of the business entity, configured to perform at least one licensing activity to generate royalty revenue from the at least one intellectual property asset, thereby providing income for the at least one IP owner, wherein the business entity is configured to defend the at least one intellectual property asset for the at least one owner. A method of using intellectual property to generate licensing revenue includes: forming a business entity; acquiring at least one intellectual property asset from at least one IP owner who is not an employee of the business entity; generating royalty revenue from the at least one intellectual property asset; defending the at least one intellectual property asset; and providing at least one investor with at least a portion of the royalty revenue.

CLAIM TO PRIORITY

The present application claims priority under 35 U.S.C. § 119 to U.S. Provisional Application 60/460,307 filed Apr. 5, 2003. The entire contents of application Ser. No. 60/460,307 are herein incorporated by reference.

### BACKGROUND OF THE INVENTION

### FIELD OF THE INVENTION

The present invention relates generally to a system and method for generating revenue. More particularly, the present invention relates to a system and method using intellectual property to generate revenue.

### SUMMARY OF THE BACKGROUND

In the past, most of the valuation of a public company was based on the tangible assets of the company. Now, however, a significant portion of the market value of many companies is based upon intangible assets, such as technology or other intellectual property (hereafter IP assets). Presently, IP assets have been estimated to represent approximately 70% of the value of many companies in the United States. Additionally, IP assets are increasingly used to generate a substantial stream of royalty revenue or income for present day companies. This royalty revenue is generated by licensing the IP assets to third party companies. IP assets that are easily licensable include patents, copyrights, trademarks, or other technology (e.g., in the form of trade secrets).

As a result, IP asset licensing has become very important for businesses in today's economy. In recent years, the IP asset licensing industry has grown at twice the annual rate of the rest of the economy. In 1999 alone, it was estimated that over $100 billion in annual patent licensing royalties were paid. This amount is anticipated to grow to over $200 billion by the end of this decade. As a result, the IP asset licensing business has become of great interest to both those possessing valuable IP assets and those in the investment community.

Although there are many different types of IP asset owners, many IP asset owners fail to reap the financial benefits from IP asset licensing. One reason that IP asset owners fail to maximize the benefits of owning IP assets is that effectively licensing IP assets to third parties is costly, involves a large time investment, and may be unpredictable. Additionally, there is no guarantee that licensing efforts will necessarily generate royalty income.

To effectively license IP assets, it is useful to identify infringing parties, to gather proof of the infringement, to perform reverse engineering analysis, to perform assertions (reading a patent claim on a particular product to show infringement), and to execute an agreement with the infringing party. Many IP asset owners do not have sufficient resources (e.g., money, time, or expertise) to perform those tasks. Other IP asset owners are not willing to take a risk on such unpredictable outcomes.

In short, many IP asset owners choose to forego a potentially substantial portion of the royalty income that might be derived from their IP assets. Other IP asset owners refuse to risk millions of dollars to assert their IP asset rights with no guarantee of success. Particularly when the economy is in a downturn, many IP asset owners choose to take no action, thereby foregoing the potential royalty income.

Presently, some businesses attempt to provide IP asset owners with a low cost or contingency solution to exploit their IP assets. Such businesses promise to perform all the tasks associated with licensing IP assets, in return for only a percentage of the royalty revenues paid by each licensee. If the IP assets are not licensed, the IP asset owner may pay no fees. Thus, the cost of the licensing services is contingent on the success of the licensing effort. Therefore, the IP asset owner is not required to pay any fees for the licensing efforts unless royalty revenue is generated. Such a contingency solution may be attractive to some IP asset owners because it enables them to enter the licensing market without assuming the risks and incurring the above-described costs.

However, this contingency solution is disadvantageous for many IP asset owners. One disadvantage is that the contingency solution fails to enable the IP asset owner to defend against non-litigation infingement claims by third parties. Additionally, the contingency solution only provides the IP asset owner with a share of the royalty stream. The contingency solution also does not provide a method for IP asset owners to team up with other IP asset owners to form a larger IP asset portfolio to generate a greater amount of royalty revenue to be shared by a team of IP asset owners. Additionally, the contingency solution does not provide different IP asset owners with a way to participate in the overall success of the business entity providing the contingency services. That is, if the business is successful in generating licensing revenue for one IP asset owner client, another IP asset owner client has no way to participate in that success. Consequently, individual IP asset owner clients may be competing with each other for the full attention and service of the contingency licensing business.

Another aspect of the contingency business model is that the value of a contingency business is limited to the royalty income it derives for its clients. The business never actually acquires or develops any assets of its own that have actual value. Therefore, such a business model may not be attractive to those looking to invest in new businesses. Therefore, it is difficult for contingency businesses to raise funds or to go public.

### SUMMARY OF THE INVENTION

To address at least some of the above-described difficulties, the present inventors developed a system and method to enable IP asset owners to enter the IP asset licensing business with reduced risk from the high cost associated with licensing activities, and with fewer drawbacks than the contingency solution above-described. To enable these benefits, the present inventors propose to form a business entity that acquires IP assets from IP asset owners using various methods, including licensing, purchasing, technology transfers, joint ventures, alliances, as well as other methods known to those of skill in the art. The IP asset portfolio may include, but is not limited to, full ownership rights, partial ownership rights, licensing rights, and exclusive rights in the acquired IP assets. The resulting IP asset portfolio will therefore have a value as an asset of the business entity, and will provide the ability to generate royalty revenue for the business entity.

According to one aspect of the present invention, in return for the rights acquired relative to a particular IP asset from a specific IP asset owner, the business entity may share with the IP asset owner any royalty revenue it generates from licensing the IP asset, but the IP asset owner does not have to pay the business entity's costs associated with the licensing activities. Thus, the business entity provides an IP asset owner with the ability to test the licensing value of a specific IP asset and to receive royalty revenue that the IP asset owner would normally not receive, without having to bear the costs associated with such activities.

Another aspect of the present invention enables the generation of finding for IP asset acquisition and licensing activities by various methods, including self-funding by the founders of the business entity and by selling ownership interests to investors. The investors may include non-IP asset owners having a desire to invest funds in an IP asset licensing business for a return on an investment, and IP asset owners having a return for the benefits of being an owner of a large, diverse portfolio of IP assets. Such benefits include, but are not limited to, defensive protection and the ability to generate revenue from licensing IP assets owned or developed by other IP asset owners. According to this aspect of the invention, it is possible to provide an IP asset owner with a share of the royalty revenue generated from licensing that IP asset owner's particular IP assets, as well as licensing revenue obtained from licensing activities with investors.

Another aspect of the present invention provides a business entity that is an investment trust. The investment trust (e.g., an IP asset trust) engages in the business of acquiring IP assets. The IP assets acquired by the IP asset trust may include licensing rights and ownership rights of IP assets from a plurality of IP asset owners. The acquired IP assets may include patents related to a variety of different technologies (e.g., optics, data networking, wireless systems, wireless devices, etc.), trademarks, copyrights, trade secrets, know-how, software, technology, as well as many others known to those of skill in the art. The resulting IP asset trust may be diverse both in terms of the type of P assets owned by the trust and in terms of the breadth of the technology covered by the IP assets.

Additionally, according to the present invention, the IP asset trust may be designed to provide an IP asset owner with an option to use the ownership interest in the IP asset trust as collateral to defend against non-litigation third party claims. For example, if a third party makes an infringement claim against an IP asset owner or investor, the IP asset trust may intercede, if requested by the IP asset owner, and may offer a portion of the IP asset owner's interests in the IP asset trust as a settlement option for the claim. If the settlement offer is accepted, the third party may then own an interest in the IP asset trust and may obtain the above-described investor benefits. Alternatively, the third party may obtain the cash value of the IP asset owner's interest in the trust.

### BRIEF DESCRIPTION OF THE DRAWINGS

FIG. 1 illustrates a block diagram of a non-limiting first embodiment of a system according to the present invention; and

FIG. 2 illustrates a flow diagram of a method for generating revenue in accordance with a non-limiting embodiment of the present invention.

### DESCRIPTION OF THE EMBODIMENTS

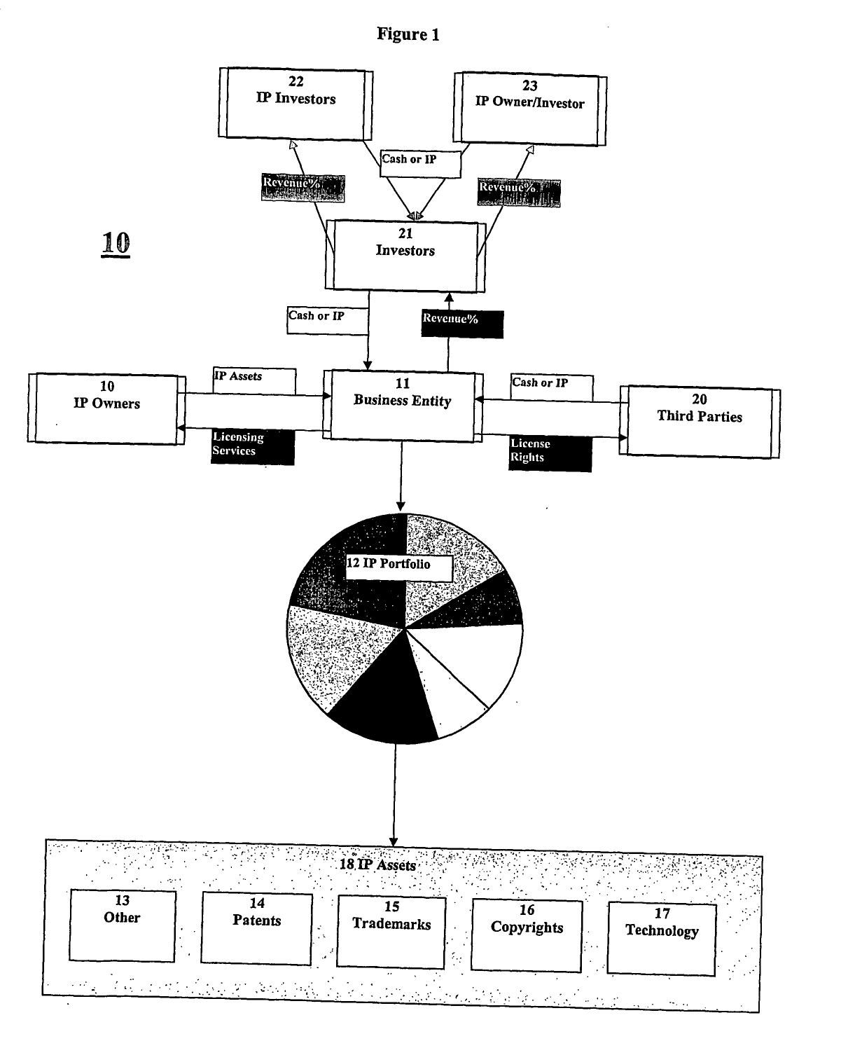

With reference to FIG. 1, the system 10 of the present invention includes a business entity 11 owned by investors 21. Investors 21 may include IP asset investors 22 and IP asset owners/investors 23. IP asset investors 22 may include corporations or individual investors. IP asset owners/investors 23 may include individual inventors as well as corporations possessing IP assets. Business entity 11 may own an IP asset portfolio 12. IP asset portfolio 12 includes IP assets 18, including patents 14, trademarks 15, copyrights 16, technology 17, and other IP assets 13 (e.g., trade secrets and know-how) acquired from IP asset owners 31. IP asset owners 31 may be large corporations, small businesses, individual inventors, distressed companies, or other entities possessing IP assets, including bankruptcy trustees.

The IP assets 18 are not necessarily those that conform to a standard (e.g., MPEG or others known to skill in the art). Rather, IP assets 18 may represent a broad array of technologies and creative enterprises.

Business entity 11 may acquire IP assets 18 from IP asset owners 31 using various known acquisition methods, such as licensing, purchasing, technology transfer, joint ventures, alliances, as well as other methods known to those of skill in the art. The IP assets 18 and IP asset portfolio 12 may include full ownership rights, partial ownership rights, licensing rights, and exclusive rights in particular IP assets. When acquiring IP assets 18, the business entity 11 may use IP asset valuation techniques to determine that each asset adds some value to the IP asset portfolio 12. The IP asset valuation techniques may identify IP assets having market value for a particular business or businesses, and IP assets having value for generating licensing revenue. The resulting IP asset portfolio 12 may therefore be an asset held by business entity 11, and may provide the ability to generate royalty revenue for business entity 11.

IP asset owners 31 who contribute IP assets 18 to the IP asset portfolio 12 do not include employees of the business entity 11. Specifically, the IP asset owners may not include employees of the business entity 11 who are or may become under an obligation to assign their IP assets to the business entity 11. Thus, the present invention is distinct from a corporation that endeavors to license the IP assets of its employees prior to or after an assignment of the IP assets to the corporation.

The business entity 11 generally engages in activities needed to generate licensing revenue from IP assets 18. These activities include, but are not limited to, identifying parties that infringe on patents 14, gathering evidence of such infringement, performing an assertion against the infringing party, and negotiating and drafting patent licensing agreements with the infringing party, such that the patent licensing agreements require royalty payments to business entity 11.

Depending upon the terms associated with the acquisition of specific IP assets from a particular IP asset owner 31, business entity 11 may share certain royalty payments obtained from the licensing of the particular IP assets with any given IP asset owner. Additionally, depending on the ownership rights of any particular investor 21, business entity 11 may share with the investor 21 the royalty revenue the business entity 11 receives for licensing any of the IP assets 18 in the IP asset portfolio 12.

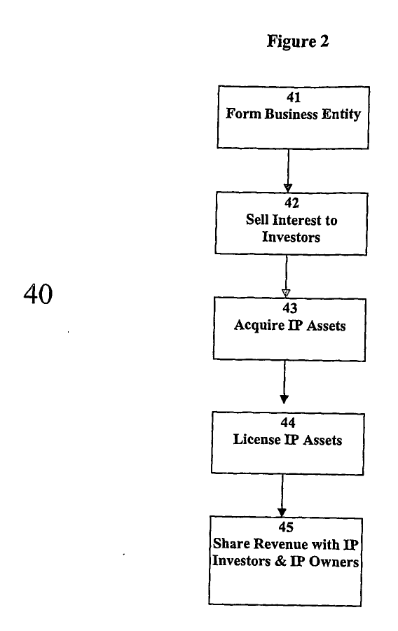

Referring to FIG. 2, FIG. 2 illustrates a flow diagram of a method 40 for generating revenue in accordance with the present invention. As shown, method 40 begins with step 41 of forming a business entity. The business entity may be, for example, an investment trust. At step 42, ownership interest in the business entity is sold to a set of investors. In step 43, a set of intellectual property assets is acquired from a set of intellectual property owners to form an IP asset portfolio that is owned by the business entity. At step 44, the business entity performs licensing activities to generate royalty revenue for the business entity. Step 45 occurs when the business entity shares at least a portion of the generated income with the investors and intellectual property owners, without the intellectual property owners having to pay for the costs associated with the activities involved in generating the royalty revenue from the intellectual property assets.

Thus, method 40 provides a way for intellectual property owners to test the value of and generate income from their IP assets without using their own money. At the same time, the method provides a way for an intellectual property licensing business to not only generate royalty revenue, but to also build a valuable asset in the form of a group of IP assets which may be used to attract investors in business. Additionally, the method provides investors with an investment that provides a stream of royalty revenue and ownership of a valuable portfolio of intellectual property assets.

According to one non-limiting embodiment of the present invention, business entity 11 may include an IP asset trust, as earlier described. Such an IP asset trust may operate under similar principals as those set forth for professionally managed mutual funds or investment trusts. For example, it may be managed by a select team of skilled IP asset technology and licensing professionals that have working knowledge and success in the business of IP asset revenue generation.

The trust may use various techniques, including options, strategic alliances, conditional grants, partnerships, joint ventures, and other forms of technology transfer arrangements familiar to those of skill in the art. The trust may employ a combination of cash, cross-licensing, shares, royalties, and other methods known to skill in the art to compensate IP asset owners 13. Through these techniques, an IP asset trust according to the present invention provides a low-cost method of acquiring valuable IP assets from various sources and converting the IP assets into royalty streams or into valuable products to optimize the return on investment (ROI) for investors 21. Through these techniques, the IP asset trust essentially converts legal departments of IP asset owners 31 into profit centers and yields substantial shareholder value.

One implementation of an IP trust is a professionally managed trust that acquires IP assets and select technologies from IP asset owners 31. The IP asset owners 31 may include distressed companies, small businesses, bankruptcy trustees, and individual inventors. The trust may acquire the valuable IP assets using various technology transfer methods, including licensing, acquisition, alliances, and other methods known to those of skill in the art. The IP asset trust may then structure various licensing programs to generate passive royalty income from the acquired IP assets for the investors. In short, such an IP asset trust brings together investors 21 and IP asset owners 31 to form a portfolio of patents, trademarks, and other useful technologies. The acquired IP assets may be used to create royalty income for both the acquired IP asset owners 31 and the investors 21.

Initially, the IP asset trust may minimize securities issues by limiting investor participation to only those investors 21 that also qualify as accredited investors. In the long term, however, the IP asset trust may create a registered offering or IPO that may provide small companies and individual investors with the unique opportunity to invest in the IP asset trust. The IP asset trust may also enable IP asset owners/investors 23 to contribute IP assets to the trust to exploit the value of their own IP assets while simultaneously receiving the benefits of being part of a larger and more valuable IP asset portfolio 12. As previously explained, these benefits include obtaining royalty income based on the success of the entire portfolio as well as defensive benefits.

A business entity 11 according to the present invention may prove to be attractive to IP asset owners such as small business, individual inventors, failed telecoms, distressed companies, and other companies that own valuable IP assets that are not presently being exploited for value. Many such IP asset owners do not have the time or expertise to manage their IP assets very effectively, to license their IP asset rights for royalty income, or to examine their IP assets for target businesses that either use or would want to use their IP assets.

The IP asset trust may also generate revenue by providing IP asset related services, such as IP asset valuation services for entities that require assistance in valuing their business or assets for sale or other acquisition.

To overcome recent economic downturns, many companies need to develop additional profit centers to help drive long term profitability and to power future IPOs. Many companies have core business units experiencing increasing cost and price pressures. The future of these companies may depend on their ability to continue taking advantage of new opportunities. A new opportunity, such as IP asset, can create substantial licensing revenue for these companies with minimal risk and overhead. However, many companies do not know the value of their own IP assets. Many companies have valuable IP assets that they are not exploiting. This lack of exploitation is not only a disservice to their shareholders, but may also constitute a breach of the fiduciary duties of officers and directors to prevent waste. According to the present invention, a business entity may provide these companies with aid to properly exploit and develop their IP assets and to produce a valuable portfolio and revenue stream for the shareholders of each company.

Developing and preserving IP assets may also be expensive and a complex process for many companies. To overcome these difficulties, a business entity according to the present invention may provide acquisition services, licensing services, and valuation services to IP asset owners, together with other services such as defensive benefits. A valuable IP asset portfolio can act as a strong defensive tool to avoid litigation exposure to the IP assets of others. Many companies only learn this painful lesson when they are forced to pay millions of dollars to purchase a license under threat of lawsuit.

For example, companies with strong balance sheets and deep pockets have high risk of being subjected to patent infringement claims. The business entity of the present invention may provide certain IP asset owner/investors with at least a portion of the IP asset portfolio of the business entity to defend against third party claims. In other words, the business entity of the present invention may act as a form of insurance against infringement litigation for certain IP asset owners.

With regard to acquiring assets, one method of determining whether a particular target IP asset is desirable for acquisition is to: (1) identify the field of technology or the type of product in which the IP asset may be used (this may be done, for example, by reading the patent and consulting with a technical expert); (2) estimate the size of the market for the identified technology or product (once the product type and/or field of technology is identified, such market information is readily available from many sources); (3) make a list of companies that make the identified products or technology (this list can be obtained, for example, by searching the Internet using specific search terms to identify articles, advertisements, and press releases); (4) gather literature and information that describes the operation and features of the identified products made and/or sold by the identified companies using the IP assets (such information is often found at the companies' web site); and (5) use an attorney that is familiar with the target IP assets to review the product literature with a technical expert familiar with the identified technology and products to determine the likelihood of use (this is a highly specialized practice that may involve mapping the IP asset, e.g., a patent claim, against the functions and features of the identified product). According to one non-limiting embodiment of the present invention, an IP asset having a high likelihood of use in an industry that has a large market should be identified as an IP asset that is desirable for acquisition.

Once the IP asset has been acquired, the business entity may perform a more detailed evaluation (e.g., reverse engineering) if the product is identified as having a high likelihood of use. The business entity may also determine whether there is actual use of the IP asset, gather the proof of such use, and present that proof to an infringing party in an effort to generate royalty income.

In general, once an IP asset has been selected for acquisition, the business entity may select the best method of assertion, may identify targets, and may set up suitable value and pricing strategies for the licenses. Valuation and pricing may largely depend on the nature of the license, the quality of the available information on sales, costs, and profitability of the potential licensees, and establish royalty rates charged by others in the industry for similar IP assets.

The business entity according to the present invention may also use various licensing models for its IP assets. These models include, but are not limited to, fixed sum, fixed percent, variable percent or sum, or a combination of these methods or other methods known to those of skill in the art. To produce royalty revenue with minimal expenses, the business entity may conduct all licensing negotiations, but may partner with at least one law firm to aid in any required negotiation on a fixed-fee basis. Additionally, the business entity may consider selling any rights to sue a third party law firm or company to generate additional revenue for its investors.

According to one non-limiting embodiment of the present invention, the business entity may operate in the form of a limited partnership. The limited partnership may be operated and managed by a managing partner. This limited partnership structure ensures privacy and allows for maximum flexibility in creating an IP asset portfolio that produces passive royalty income streams for the limited partners, IP asset investors, and IP asset owners/investors.

For example, following an IPO or other registered offering, the limited partnership may serve as an investment vehicle for small investors. The managing entity may be operated by a multi-disciplinary team composed of IP asset professionals that are responsible for both acquiring and developing an IP asset portfolio and for the generation of licensing income from those assets. The managing entity may own an interest in the limited partnership and may be paid an annual management fee.

Additionally, the managing entity may appoint a Board of Advisors (hereafter, the Advisory Board) made up of representatives of IP asset owners/investors and IP asset investors, and including at least seven members. The Advisory Board may aid the limited partnership in the identification, acquisition, supervision, and management of the IP asset portfolio in key areas of technology. The managing entity may also form a Licensing Committee (hereafter, the Licensing Committee), including people selected to consult with and make recommendations to the managing entity regarding the selection of potential licensees, market analysis, and the valuation and pricing of IP assets 12.

The managing entity may also form an Advisory Committee (hereafter, the Strategic Advisory Committee) including between approximately 5 to 7 members. The Strategic Advisory Committee may be composed of senior representatives or leaders from national and international technology sectors in the scientific community, including senior technology or marketing figures recommended by the IP asset owners/investors and IP asset investors. The managing entity may consult with the Strategic Advisory Committee on matters concerning market directions, strategic IP asset business decisions, technology, and technical aspects of the IP asset portfolio and related issues. The members of the Strategic Advisory Committee may be selected by the managing entity.

Obviously, numerous modifications and variations of the present invention are possible in light of the above teachings. It is therefore to be understood that within the scope of the appended claims, the invention may be practiced otherwise than as specifically described herein.

1. A method of using intellectual property to generate licensing revenue, comprising:
forming a business entity;
acquiring at least one intellectual property asset from at least one IP owner who is not an employee of the business entity;
generating royalty revenue from the at least one intellectual property asset;
defending the at least one intellectual property asset; and
providing at least one investor with at least a portion of the royalty revenue.

2. The method according to claim 1, wherein the business entity includes at least one of an investment trust and a limited partnership.

3. The method according to claim 1, wherein the at least one intellectual property asset includes at least one of a patent, a trademark, a copyright, a trade secret, and software.

4. The method according to claim 1, wherein the at least one investor includes at least one of an intellectual property asset owner, an inventor, and a corporation.

5. The method according to claim 1, wherein an owner of the at least one intellectual property asset is not required to pay the business entity for the licensing.

6. The method according to claim 1, wherein the acquiring includes acquiring at least one of licensing rights, exclusive rights, ownership rights, a joint venture, and franchising rights.

7. A system for generating royalty revenue, comprising:
a business entity configured to acquire rights to at least one intellectual property asset from at least one IP owner who is not an employee of the business entity; and
a licensing group, operating on behalf of the business entity, configured to perform at least one licensing activity to generate royalty revenue from the at least one intellectual property asset, thereby providing income for the at least one IP owner,
wherein the business entity is configured to defend the at least one intellectual property asset for the at least one owner.

8. The system according to claim 7, wherein the at least one owner is not required to pay the business entity for the at least one licensing activity.

9. The system according to claim 8, wherein the rights includes at least one of licensing rights, exclusive rights, ownership rights, and franchising rights.

10. The system according to claim 7, wherein the business entity is configured to use at least one of a technology transfer, a purchase, a license, a joint venture, and an alliance to acquire the rights.

11. The system according to claim 7, further comprising at least one investor in the at least one business entity, wherein the business entity is configured to provide the at least one investor with at least a portion of the royalty revenue.

12. The system according to claim 11, wherein the at least one investor includes at least one of a cash investor and a second intellectual property asset owner.

13. The system of claim 7, wherein the business entity includes at least one of an investment trust and a limited partnership.

14. The system of claim 7, wherein the at least one intellectual property asset includes at least one of a patent, a trademark, a copyright, a trade secret, and software.

15. The system of claim 7, wherein the at least one owner includes at least one of an inventor, a non-inventor intellectual property asset owner, and a corporation.

16. The system of claim 7, wherein the at least one licensing activity includes at least one of a patent valuation activity and a patent assertion activity.
